(19) United States
(12) Patent Application Publication
(10) Pub. No.: US 2013/0281602 A1
(43) Pub. Date: Oct. 24, 2013

(54) Thermo-responsive polymer covalently bound with a peptide

(71) Applicants: Alberto Saiani, Prestbury (GB); Aline Miller, Prestbury (GB); Roland Callens, Tielt (BE); Laurent Jeannin, Brussels (BE); Wafa Moussa, Nice (FR)

(72) Inventors: Alberto Saiani, Prestbury (GB); Aline Miller, Prestbury (GB); Roland Callens, Tielt (BE); Laurent Jeannin, Brussels (BE); Wafa Moussa, Nice (FR)

(73) Assignee: SOLVAY SA, Brussels (BE)

(21) Appl. No.: 13/877,910

(22) PCT Filed: Oct. 6, 2011
(86) PCT No.: PCT/EP2011/067479

§ 371 Date: Jul. 12, 2013

(30) Foreign Application Priority Data
Oct. 8, 2010 (EP) 10187069.9
Oct. 8, 2010 (EP) 10187070.7

(51) Int. Cl. C08F 122/38; C08L 89/00; C08G 83/00

(52) U.S. Cl. CPC C08F 122/38; C08G 83/00; C08L 89/00
USPC 524/498; 527/201; 526/238.1; 530/327

(57) ABSTRACT

A thermo-responsive polymer covalently bound with a peptide, wherein the peptide comprises a peptide moiety that is able to self-assemble and a functional peptide moiety comprising a bioactive sequence, and compositions comprising such thermo-responsive polymer covalently bound with a peptide. Methods for the preparation of such thermo-responsive polymers covalently bound with a peptide and the use thereof for the preparation of hydrogels.

The present application claims the benefit of the European applications No. 10187070.7 and 10187069.9, both filed on Oct. 8, 2010, herein incorporated by reference.

### DESCRIPTION

The present invention relates to a thermo-responsive polymer covalently bound with a peptide, more particularly with at least one peptide comprising a self-assembling peptidic sequence, and compositions comprising the present thermo-responsive polymer covalently bound with a peptide. Further, the invention relates to methods for the preparation of the present thermo-responsive polymers covalently bound with a peptide and the use thereof for the preparation of hydrogels and specifically hydrogels for cell culture, tissue engineering or tissue repair.

Self-assembling peptides comprising alternating hydrophobic and hydrophilic amino acids that self-assemble into a macroscopic structure when present in unmodified form, are known in the art. For instance D. G. Osterman et al. discloses peptides designed to form amphiphilic β-strand or β-sheet structures (Journal of Cellular Biochemistry, vol. 29, p. 57-72, 1985). Another example is given by U.S. Pat. No. 7,713,923 which discloses self-assembling peptides comprising a first domain that mediates self-assembly into a macroscopic structure and a second domain comprising biologically active peptide motif, such peptides being useful in scaffolds for cell culture, tissue engineering or tissue repair.

A thermo-responsive polymer is a polymer which undergoes a physical change, such as conformational change, when exposed to external thermal stimuli such as an increase, or decrease, in temperature. The ability of thermo-responsive polymers to undergo physical changes in response to thermal stimuli classifies these polymers in the art in the category of smart materials.

The physical changes in response to thermal stimuli of a thermo-responsive polymer can be exploited in many technical fields such as separation chemistry, stationary phases, extraction of compounds, surface modifiers, drug delivery and the formation of hydrogels, especially hydrogels for cell culture.

Contrary to the behavior of most polymers in aqueous solutions, thermal-responsive polymers become less soluble, or more hydrophobic, in water at elevated temperatures. This phase transition behavior in hydrophylicity is not observed for other types of polymers such as polyethylene oxide (PEO) or polyethylene glycol (PEG) requiring for dissolution in water elevated temperatures.

A well studied thermo-responsive polymer is poly(N-isopropylacrylamide) or PNIPAAm. The temperature at which poly(N-isopropylacrylamide) undergoes a phase transition from soluble to insoluble has been determined to be approximately 32° C.

The temperature providing the above phase transition from soluble to insoluble is designated in the art as the lower critical solution temperature (LCST). In other words, at temperatures under the lower critical solution temperature, a thermo-responsive polymer is generally regarded as soluble and at temperatures above the lower critical solution temperature, a thermo-responsive polymer is generally regarded as insoluble. Generally, the lower critical solution temperature, or LCST, is determined in deionized water at a neutral pH.

It is believed that the mechanism underlying the observed change of soluble to insoluble, or phase transition, of thermo-responsive polymers at a certain temperature is caused by the conformation of the polymer. Below the lower critical solution temperature, the elongated chains of the polymer form a hydrophilic surface interacting with water and, accordingly, the polymer is soluble. However, at and above the lower critical solution temperature, the chains of the polymer condense exposing a hydrophobic surface and, accordingly, thermo-responsive polymers become insoluble.

It has been observed that the lower critical solution temperature of a thermo-responsive polymer can be shifted, for example, increasing the pressure generally results in an increased lower critical solution temperature. Lowering the pH and/or increasing the ionic strength will generally result in a decreased lower critical solution temperature or, in other words, the polymer will generally become insoluble at lower pHs and/or higher ionic strengths.

Thermo-responsive polymers can be used for the preparation of hydrogels. Hydrogels are three-dimensional networks of hydrophilic compounds, usually polymers, which have the ability to imbibe a large quantity of water and biological fluids. The network may be formed through either chemical crosslinking (covalent, ionic) or physical crosslinking (entanglements, crystallites, hydrogen bonds). Typically, hydrogels are three-dimensional structures capable of comprising at least 20wt % water in relation to the weight of the gel. Absorption of water by a hydrogel gel results in a significant increase of its dimensions, i.e. a significant swelling.

The use of thermo-responsive polymers in hydrogels provides environmental sensitive hydrogels, also designated as smart hydrogels. These smart hydrogels can undergo a reversible volume change in response to environmental stimuli such as pressure, pH, temperature or ionic strength making them especially suitable to be used in biomedical and pharmaceutical fields, in particular in the field of cell and tissue culturing.

Despite the availability of smart hydrogels, there is a continuous need for improved smart hydrogels exhibiting phase transition under specifically defined conditions and/or providing new, or improved, applications in, for example, the fields of drug delivery or cell and tissue culture.

Accordingly, it is an object of the present invention, amongst other objects, to provide a thermo-responsive polymer that can be used for providing a hydrogel suitable for cell and tissue culture providing, for example, improved cell adhesion and cell growth.

Further, it is an object of the present invention, amongst other objects, to provide a thermo-responsive polymer that can be used for providing a hydrogel mimicking the extracellular matrix (ECM) and/or being biocompatible.

Furthermore, it is an object of the present invention, amongst other objects, to provide a thermo-responsive polymer that can be used for providing a hydrogel facilitating harvesting of cultured cells and/or being more economic and practical in comparison with, for example, conventional cell culture bottles.

The above objects, amongst other objects, are met at least partially, if not completely, by a thermo-responsive polymer covalently bound with at least one peptide, wherein the peptide comprises a peptide moiety that is able to self-assemble and a functional peptide moiety comprising a bioactive sequence.

The present inventors have surprisingly discovered that through derivatisation of a thermo-responsive polymer with at least one peptide comprising a peptide moiety that is able to self-assemble and a functional peptide moiety comprising a bioactive sequence, a thermo-responsive polymer is obtained providing improved characteristics in a hydrogel such as improved cell and tissue culture characteristics, for example improved cell adhesion, facilitated harvesting, improved mimicking of the extracellular matrix (ECM) and/or improved biocompatibility. The present derivatised thermo-responsive polymers are easy to handle and/or relatively low in costs as compared to other means for cell culture.

A thermo-responsive polymer according to the present invention has a lower critical solution temperature (LCST) below which the polymer is hydrophilic and soluble due to the hydrogen bonding with water. The polymers show an extended form and are in a responsive conformation. When the temperature of the aqueous polymer solution is increased a partial displacement of water occurs, the hydrogen bonds weaken and the hydrophobic interactions increase between the hydrophobic segments of the polymer units. The polymers collapse, aggregate and phase separation occurs because the intra and intermolecular hydrogen bonds between the hydrophobic parts of the polymer molecules are favored compared to the water molecules. The polymers collapse and cannot interfere with the surroundings. This LCST phenomenon of the thermo-responsive polymer is reversible. The thermo-responsive polymers become soluble again after cooling below the LCST.

As used herein, the term “peptide” comprises peptides and peptide analogous. Peptide analogous comprise natural amino acids and non-natural amino acids. They can also comprise modifications such as glycosylations. All amino acids can be either the L- or D-isomer. The peptides or peptide analogues can also comprise amino acid mimetics that function in a manner similar to the naturally occurring amino acids. The peptides may also be formed from amino acids analogues that have modified R groups or modified peptide backbones. Peptide analogues usually include at least one bond in the peptide sequence which is different from an amide bond, such as urethane, urea, ester or thioester bond. Peptides or peptide analogues according to the present invention can be linear, cyclic or branched and are preferably linear.

As used herein, the term “amino acid” (Xaa) is intended to denote any compound comprising at least one NR₁R₂ group, preferably NH₂ group, and at least one carboxyl group. The amino acids of this invention can be naturally occurring or synthetic. The natural amino acids, with exception of glycine, contain a chiral carbon atom. Unless otherwise specifically indicated, the compounds containing natural amino acids with the L-configuration are preferred. The aminoacids can be selected from, for example β-alanine, γ-aminobutyric acid, 5-aminovaleric acid, glycine, phenylglycine, homoarginine, alanine, valine, norvaline, leucine, norleucine, isoleucine, serine, isoserine, homoserine, threonine, allothreonine, methionine, ethionine, glutamic acid, aspartic acid, asparagine, cysteine, cystine, phenylalanine, tyrosine, tryptophan, lysine, hydroxylysine, arginine, histidine, ornithine, glutamine, citrulline, proline, and 4-hydroxyproline. Amino acid residues are abbreviated as follows throughout the application: Alanine is Ala or A; β-Alanine is β-Ala; γ-aminobutyric acid is GABA; 5-aminovaleric acid is Ava; Arginine is Arg or R; Homoarginine is Har or hR; Alanine is Ala or A; Asparagine is Asn or N; Aspartic acid is Asp or D; Cysteine is Cys or C; Glutamic acid is Glu or E; Glutamine is Gln or Q; Glycine is Gly or G; Histidine is His or H; Homoserine is Hse; Hydroxylysine is Hyl; Isoleucine is Ile or I; Leucine is Leu or L; Lysine is Lys or K; Methionine is Met or M; Norleucine is Nle; Ornithine is Orn; Phenylalanine is Phe or F; Proline is Pro or P; 4-Hydroxyproline is Hyp or O; Serine is Ser or S; Threonine is Thr or T; Tryptophan is Trp or W; Tyrosine is Tyr or Y; Valine is Val or V.

The present peptide covalently bound, or covalently attached, to the thermo-responsive polymer comprises at least two separate moieties, defined by their function.

The first moiety of the peptide provides self-assembly, i.e. the domain folds into a specifically defined conformation in contrast with non-self-assembling peptide domains having many random conformations. Self-assembling amino acid sequences are known in the art and, according to the present invention, peptide sequences capable of assembling into a β-sheet, a coiled coil a-helix structure, a peptide triple helix structure, or combinations thereof are preferred.

A peptide moiety that is capable of self-assembly into a coiled coil structure is, for example, a peptide amino acid sequence providing an a-helical coiled coil structure. This is a tertiary structure which depends on the amphiphilic pattern of the peptides primary sequence. The peptide moiety of this embodiment comprises a variety of hydrophobic and polar residues, and is usually composed of at least 10 amino acids. For example, the helix peptide moiety is designed to have all the polar residues on one face of the helix and all the hydrophobic residues on the other side of the helix. This helix can form part of two or more helix chains and form a coiled coil structure. The helices are associated together through hydrophobic interaction and form a coiled coil. The sequence of the peptide moiety can for example be a leucine zipper sequence.

Peptide moieties capable of self-assembling into a β-sheet provide β-sheet stabilized by inter-molecular hydrogen bonding perpendicular to the peptide chain. The self-assembling occurs through hydrogen bond interactions between beta strands. The beta strand is a stretch of polypeptide chain with a backbone in an almost fully extended conformation. The β-sheet structure can be formed either from parallel or anti-parallel β-strands. An example of a β-sheet according to this embodiment is a peptide moiety that is able to self-assemble in an amyloid-like structure. Peptide moieties capable of self-assembling into a β-sheet comprise typically at least 5 or 6 amino acids.

According to a preferred embodiment of the present invention the peptide moiety that is able to self-assemble, can form a hydrogel when the peptide is provided in suitable conditions.

According to another preferred embodiment of the present invention, the peptide moiety that is able to self-assemble into a β-sheet is an octapeptide moiety comprising alternating hydrophobic and charged amino acids. Hydrophobic amino acids are often selected from the group consisting of Phenylalanine (Phe or F), Tryptophan (Trp or W), Tyrosine (Tyr or Y), Isoleucine (Ile or I), Alanine (Ala or A), Leucine (Leu or L), Valine (Val or V), and Norleucine (Nle); in particular from Phenylalanine (Phe or F), Tryptophan (Trp or W), Tyrosine (Tyr or Y), Isoleucine (Ile or I), and Norleucine (Nle). Charged amino acids are usually selected from the group consisting of Arginine (Arg or R), Aspartic acid (Asp or D), Glutamic acid (Glu or E), Lysine (Lys or K), and Histidine (His or H); particularly from Arginine (Arg or R), Aspartic acid (Asp or D), Glutamic acid (Glu or E), and Lysine (Lys or K).

Preferred octapeptides comprise one type of hydrophobic amino acids and two types of charged amino acids. Especially suitable octapeptide are formed by the combination of two sequences chosen independently from the group consisting of FEFE, FEFK, FEFD, FEFR, FRFR, FRFK, FRFE, FRFD, FKFE, FKFK, FKFR, FKFD, FDFD, FDFE, FDFR, FDFK, WEWE, WEWK, WRWR, WEWK, WKWE, WEWR, WRWE, WKWR, WRWK, WDWD, WDWE, WEWD, WDWK, WKWD, WDWR, WRWD, IEIE, IEIK, IRIR, IEIK, IKIE, IEIR, IRIE, IKIR, IRIK, IDID, IDFE, IEID, IDIK, IKID, IDIR, IRID, YEYE, YEYK, YRYR, YEYK, YKYE, YEYR, YRYE, YKYR, YRYK, YDYD, YDYE, YEYD, YDYK, YKYD, YDYR, YRYD, Nle-E-Nle-E, Nle-K-Nle-K, Nle-R-Nle-R, Nle-E-Nle-K, Nle-K-Nle-E, Nle-E-Nle-R, Nle-R-Nle-E, Nle-K-Nle-R, Nle-R-Nle-K, Nle-D-Nle-D, Nle-D-Nle-E, Nle-E-Nle-D, Nle-D-Nle-K, Nle-K-Nle-D, Nle-D-Nle-R, and Nle-R-Nle-D. The two sequences can be the same or different, especially the same.

The octapeptide moiety might for instance be selected from the group consisting of FEFKFEFK, FEFEFKFK, FDFKFDFK, FDFDFKFK, FEFRFEFR, FEFEFRFR, YDYKYDYK, YDYDYKYK, YEYRYEYR, YEYKYEYK, YEYEYKYK, WEWKWEWK, WEWEWKWK, WDWKWDWK, WDWDWKWK. Most preferably the amino sequences are FEFKFEFK or FEFEFKFK.

The second moiety of the peptide according to the invention provides a bioactive sequence. A bioactive sequence according to the present invention is an amino acid sequence providing a biological activity to growing cells such as cell attachment, cell migration, cell overgrowth, and/or induction of a cellular phenotype. An example of induction of a cellular phenotype is the transformation of pluri or omni potent cells, for example stem cells, into dedicated cell types, such as bone cells, muscle cells, insulin secreting cells etc.

The present moiety, of the peptide according to the invention providing a bioactive sequence can also be an amino acid sequence influencing cellular function by interacting with receptors on the cells that may be involved in a cellular cascade reaction in the cells.

According to a preferred embodiment, the functional peptide moiety comprising a bioactive sequence is a cell adhesion providing amino acid sequence, or, in other words, the functional peptide moiety allows adhesion of cells to the derivatised thermo-responsive polymer. Adhesion of cells can be provided by binding to cell surface receptors or glycoproteins. Amino acid sequences providing binding to cell surface receptors or glycoproteins are generally known in the art.

In a more preferred embodiment, the present functional peptide moiety comprises at least one RGD or hRGD sequence (referred to as (h)RGD sequence in the present specification).

In a first aspect of this more preferred embodiment, the (h)RGD sequence may comprise additional amino acids covalently bound to its N-terminus (NH₂). The sequence may for instance be selected from (Xaa)n-(h)RGD sequences wherein Xaa is any natural or unnatural amino acid and n is 1 to 10. The n Xaa amino acids may be the same or different. Suitable examples of such sequences are G(h)RGD, YhRGD, YG(h)RGD, GGGG(h)RGD, βAla-(h)RGD, GABA-(h)RGD, and Ava-(h)RGD.

In a second aspect of this more preferred embodiment, the (h)RGD sequence may comprise additional amino acids covalently bound to its C-terminus (COOH). The bioactive sequence may for example be selected from (h)RGD-(Xaa)ₘ sequences wherein Xaa is any natural or unnatural amino acid and m is 1 to 10. The m Xaa amino acids may be the same or different. Suitable examples of such sequences are (h)RGDS, (h)RGDY, (h)RGDF, (h)RGDK, (h)RGDV, (h)RGDT (h)RGDWP, (h)RGDYK, (h)RGDFK, (h)RGDSP, (h)RGDSPK, (h)RGDSY, (h)RGDNP, (h)RGDTP, and (h)RGDSP, in particular (h)RGDWP.

In a third aspect of this more preferred embodiment, the first and second aspects as described above may be combined, the (h)RGD sequence comprising additional amino acids covalently bound to both its N- and C-terminus, i.e. (Xaa)ₙ-(h)RGD-(Xaa)ₘ where Xaa is any natural or unnatural amino acid selected independently from one another, n is 1 to 10, and m is 1 to 10. Such sequences may for instance be selected from the group consisting of G(h)RGDS, G(h)RGDY, G(h)RGDF, YG(h)RGD, G(h)RGDSY, G(h)RGDSP, G(h)RGDSPK, Y(h)RGDS, G(h)RGDTP, G(h)RGDSPK, G(h)RGDSP, G(h)RGDK, GGGG(h)RGDS, G(h)RGDNP, and combinations thereof; in particular G(h)RGDS, G(h)RGDSY.

According to a particularly preferred embodiment, the present functional peptide moiety comprises one or more sequences selected from the group consisting of Arg-Gly-Asp (RGD), Har-Gly-Asp (Har-GD or hRGD), RGDS, GRGDS, GRGDY, GRGDF, YGRGD, GRGDSY, GRGDSP, GRGDSPK, YRGDS, GRGETP, GRGESP, GRGDTP, GRGDSPK, GRGDSP, GRGDK, GRADSPK, GGGGRGDS, GRGDNP, RGDYK, RGDFK,LDV, REDV, RGDV, LRGDN, IKVAV, YIGSR, PDSGR, RNAIEIIKDA, RGDT, DGEA, VTXG, Arg-Gly-Asp-Trp-Pro (RGDWP), Har-Gly-Asp-Trp-Pro (Har-GDWP or hRGDWP), analogues and combinations thereof. Other suitable sequences are for instance GRGDSY, QHREDGS, SDKP, analogues and combinations thereof. Still further suitable sequences are for example collagen mimics, in particular (PPG)_{z}, (PEG)_{z}, (PDG)_{z}, (PKG)_{z}, (PRG)_{z} wherein z is 1 to 50, as well as analogues and combinations thereof.

In a further particular embodiment, the present functional peptide moiety comprises at least one (h)RGD sequence linked on its N-terminus to mercaptopropionic acid (Mpr), the (h)RGD sequence optionally comprising additional amino acids its N- and/or C-terminus. Such a sequence can read Mpr-(Xaa)ₙ-hRGD-(Xaa)ₘ wherein Xaa is any natural or unnatural amino acid selected independently from one another, n is 0 to 10, and m is 0 to 10. In a still further particular embodiment, two mercaptopropionic acid moieties may be covalently bound together, in particular via a disulfur bond. Such sequences typically read (Xaa)ₘ-DGhR-(Xaa)ₙ-Mpr-Mpr-(Xaa)_{n′}-hRGD-(Xaa)_{m′} wherein (Xaa) is any natural or unnatural amino acid selected independently from one another, n and n′ range independently from 0 to 10, and m and m′ range independently from 0 to 10.

In a more particularly preferred embodiment, the sequence is selected from the group consisting of RGD, hRGD, RGDS, GRGDS, GRGDY,GRGDSY, IKVAV, YIGSR, PDSGR, RNAIEIIKDA, DGEA, VTXG, GHK, QHREDGS, RGDWP, hRGDWP,(POG)_{z} (where z=4-10), (PPG)_{z} (where z=4-10), and analogues or combinations thereof. Most preferred sequences are selected from the group consisting of Arg-Gly-Asp (RGD), Har-Gly-Asp (Har-GD or hRGD), Arg-Gly-Asp-Trp-Pro (RGDWP) and Har-Gly-Asp-Trp-Pro (Har-GDWP or hRGDWP), and analogues or combinations thereof; especially preferred sequences being RGDWP or hRGDWP sequences.

According to a particularly preferred embodiment, the present functional peptide moiety comprises one or more Har-Gly-Asp-Trp-Pro (Har-GDWP or hRGDWP) sequences, such as two, three, four, five, six, seven, eight, nine or ten Har-GDWP (or hRGDWP) sequences.

According to another particularly preferred embodiment, the present functional peptide moiety comprises one or more RGDWP sequences, such as two, three, four, five, six, seven, eight, nine or ten RGDWP sequences.

Har-GDWP (or hRGDWP) or RGDWP, and their derivatives provide the advantage of mimicking cell adhesion proteins in the extracellular matrix and subsequently can bind integrin proteins on the cell surface.

According to the present invention, the thermo-responsive polymer is covalently bound with at least one peptide, such as at least 5, 10, 20, 50, 100, 150, 200 or more peptides. “Covalently bound” within the present context indicates that the present peptides are attached to the present thermo-responsive polymer through a covalent linkage. Such linkage can be directly, i.e. a covalent bond between the atoms of the thermo-responsive polymer and the atoms of the peptide or indirectly, i.e., through a linking group. Examples of suitable linkages are for instance thioether linkage, amino linkage, amido linkage, ester linkage or ether linkage. Suitable examples of linking groups are linear or branched alkanes, especially polymethylene group comprising 1 to 10 carbon atoms. Other examples of linking groups are for instance polyether groups, such as polyethylene glycol (PEG).

According to a preferred embodiment of the present invention, the linkage is
a thioether linkage, preferably according to the formula:

—S—(CH₂)ₓ—[C(O)]_{y}—

wherein x is 0-10, usually x is 1-10, preferably x is 1, 2, 3 or 4, more preferably x is 2 or 3, most preferably x is 3; y is 0 or 1;
an amino linkage, preferably according to the formula:

—NH—(CH₂)ₓ—[C(O)]_{y}—

wherein x is 0-10, preferably x is 1, 2, 3, 4 or 5, more preferably x is 1, 2, 3 or 4; y is 0 or 1;
an amido linkage, preferably according to the formula:

—C(O)—NH—(CH₂)ₓ—[C(O)]_{y}—

wherein x is 0-10, preferably x is 1, 2, 3, 4 or 5, more preferably x is 1, 2, 3 or 4; y is 0 or 1;
an ester linkage, preferably according to the formula:

—C(O)—O—(CH₂)ₓ—[C(O)]_{y}—

wherein x is 1-10, preferably x is 1, 2, 3 or 4; y is 0 or 1;
an ether linkage, preferably according to the formula:

—O—(CH₂)ₓ—[C(O)]_{y}—

wherein x is 0-10, preferably x is 1, 2, 3 or 4; y is 0 or 1.

According to a further preferred embodiment of the present invention, the amido and ester linkages may be represented as follows:
amido linkage according to the formula:

—CH₂—C(R)—C(O)—NH—(CH₂)ₓ—[C(O)]_{y}—

wherein x is 0-10, preferably x is 1, 2, 3, 4 or 5, more preferably x is 1, 2, 3 or 4; y is 0 or 1; and R is H, an alkyl group having from 1 to 10 carbon atoms which is optionally substituted by at least one halogen atom;
an ester linkage, preferably according to the formula:

—CH₂—C(R)—C(O)—O—(CH₂)ₓ—[C(O)]_{y}—

wherein x is 1-10, preferably x is 1, 2, 3 or 4; y is 0 or 1; and R is as defined above.

More particularly, in this further preferred embodiment, R is H, methyl, ethyl, n-propyl or isopropyl each optionally substituted by at least 1 halogen atom; very preferably R is H, a methyl or an ethyl group; most preferably, R is methyl.

In the preferred and further preferred embodiments described above, the thermo-responsive polymer is usually attached to the linkage on the left side of the formulas as described above, i.e. via a covalent bond on the side of the —S—, —NH—, —C(O)—NH—, —C(O)—O— or —O— group. The polymer may be attached to the linkage via a covalent bond, optionally through the further —CH₂—C(R)— group in the case of the further preferred embodiment described above. In this configuration, the peptide is attached to the other side of the formulas, usually via its N-terminus (i.e. via a covalent bond on the right side of the formulas).

According to a still further embodiment of the present invention, the amido and ester linkages may be represented as follows:
amido linkage according to the formula:

—C(O)—NH—(CH₂)ₓ—[O]_{y}—[NH]_{y′}—

wherein x is 0-10, preferably x is 1, 2, 3, 4 or 5, more preferably x is 1, 2, 3 or 4; one of y and y′ is 0 and the other one of y and y′ is 1;
ester linkage according to the formula:

—C(O)—O—(CH₂)ₓ—[O]_{y}—[NH]_{y′}—

wherein x is 1-10, preferably x is 1, 2, 3 or 4; one of y and y′ is 0 and the other one of y and y′ is 1.

In this still further embodiment, the thermo-responsive polymer is generally attached to the linkage on the left side of the formulas as described above, i.e. via a covalent bond on the side of the —C(O)—NH— or —C(O)—O— group. In this still configuration, the peptide is attached to the other side of the formulas, typically via its C-terminus (i.e. via a covalent bond on the right side of the formulas).

The linkages used in the present invention may be introduced via various compounds such as for instance mercapto propionic acid (Mpr), γ-amino butyric acid (GABA), ε-amino caproic acid (ε-Ahx), 3-aminopropionic acid (β-ala), 5-amino valeric acid (5-amino pentanoic acid, Ava), or 11-amino undecanoic acid.

In the present invention, the present thermo-responsive polymer is generally covalently bound, either directly or indirectly through a linking group, with the at least one peptide through its C-terminus (—COOH) or its N-terminus (—NH₂). In other words, the present peptides are preferably attached to the present thermo-responsive polymer at their C-terminus (—COOH) or their N-terminus (—NH₂). Preferably, the present thermo-responsive polymer is covalently bound, either directly or indirectly through a linking group, with the C-terminus (—COOH) or the N-terminus (—NH₂) of the peptide moiety that is able to self-assemble or of the functional peptide moiety comprising a bioactive sequence.

According to a particularly preferred embodiment, the present thermo-responsive polymer is covalently bound, either directly or indirectly through a linking group, with the at least one peptide through a terminus, either the C-terminus (—COOH) or the N-terminus (—NH₂) of the functional peptide moiety comprising a bioactive sequence. In other words, the present peptides are preferably attached to the present thermo-responsive polymer at the C-terminus (—COOH) or the N-terminus (—NH₂) of the functional peptide moiety.

According to a preferred embodiment, the covalent coupling is at the N-terminus of the functional peptide moiety. The functional peptide moiety will be more easily blocked or hidden when the temperature is above the LCST. When the thermo-responsive polymer covalently bound to a peptide is used in a hydrogel for providing cell culture, an increase of the temperature will cause an interruption between the interaction sites of the cell with the bioactive sequence of the functional peptide moiety. This facilitates harvesting of the cells.

In a first specific embodiment, the linkage is a thioether linkage. In a further specific embodiment, the linkage is a thioether linkage and the functional peptide moiety comprises one or more sequences selected from the group consisting of Arg-Gly-Asp (RGD) and Har-Gly-Asp (hRGD) sequences and analogues or combinations thereof.

In a second specific embodiment, the linkage is selected from linkages other than a thioether linkage, preferably selected from the group consisting of amino linkage, amido linkage, ester linkage or ether linkage.

According to an especially preferred embodiment of the present invention, the at least one peptide to be covalently attached, either directly through a covalent bond or indirectly through a linking group, to the thermo-responsive polymer is introduced (as starting material) in the form of a peptide derivative.

Especially suitable peptide derivatives comprise the following blocks: [acrylate]-[linkage]-[peptide], wherein acrylate means CH₂=C(R)— group; the linkage is as defined above and is preferably selected from amino, amido, ester and ether groups, more preferably from amino, amido, and ester groups; and the peptide comprises a self-assembling peptide moiety and a functional peptide moiety comprising a bioactive sequence. Such peptide derivatives can be referred to as peptidic macromonomers. Indeed, such peptide derivatives can be mixed with other monomers, the mixture being then polymerized to lead to a modified polymer, incorporating the monomers and some peptidic macromonomers, i.e. a polymer covalently bound with the corresponding peptide moieties. The general structure of the resulting modified polymer in general corresponds to a polymer grafted at several places, through linkages, with peptide moieties. More particularly, such peptidic macromonomer may comprise the following blocks: [acrylate]-[linkage]-[functional peptide]-[self-assembling peptide] or [acrylate]-[linkage]-[self-assembling peptide]-[functional peptide], preferably [acrylate]-[linkage]-[functional peptide]-[self-assembling peptide].

Other especially suitable peptide derivatives comprise the following blocks: [polymerization initiator]-[peptide], wherein the polymerization initiator means a group able to initiate polymerization or a compound bearing a group able to initiate polymerization, preferably to initiate free radical polymerization; and the peptide comprises a self-assembling peptide moiety and a functional peptide moiety comprising a bioactive sequence. The group able to initiate polymerization may for instance be selected from the group consisting of thiols and thiocarbonylthio groups (RAFT agents). Such peptide derivatives can be referred to as peptidic polymerization initiators. Indeed, such peptide derivatives can be mixed with other monomers, polymerization being then initiated starting from the group able to initiate polymerization, more particularly via free radical polymerization, to lead to a modified polymer, covalently bound with the corresponding peptide moiety. The general structure of the resulting modified polymer generally corresponds to a linear sequence of [polymer]-[linkage]-[peptide]. It is also possible to react such peptidic polymerization initiators with a polymer moiety bearing halogen atoms that may be substituted via atom transfer radical polymerization. In this case, the general structure of the resulting modified polymer will most often correspond to a polymer grafted at several places, through linkages, with peptide moieties. More particularly, such peptidic polymerization initiators may comprise the following blocks: [polymerization initiator]-[functional peptide]-[self-assembling peptide] or [polymerization initiator]-[self-assembling peptide]-[functional peptide], preferably [polymerization initiator]-[functional peptide]-[self-assembling peptide].

In more especially preferred embodiments, the peptidic macromonomer or the peptidic polymerization initiator comprise a functional peptide selected from RGD, hRGD, RGDS, GRGDS, GRGDY,GRGDSY, IKVAV, YIGSR, PDSGR, RNAIEIIKDA, DGEA, VTXG, GHK, QHREDGS, RGDWP, hRGDWP, and analogues or combinations thereof; and a self-assembling peptide which is an octapeptide able to self-assemble into a β-sheet, formed by the combination of two sequences chosen independently from the group consisting of FEFE, FEFK, FRFR, FEFK, FKFE, FEFR, FRFE, FKFR, FRFK, FDFD, FDFE, FEFD, FDFK, FKFD, FDFR, FRFD, WEWE, WEWK, WRWR, WEWK, WKWE, WEWR, WRWE, WKWR, WRWK, WDWD, WDWE, WEWD, WDWK, WKWD, WDWR, WRWD, JEIE, IEIK, IRIR, IEIK, IKIE, IEIR, IRIE, IKIR, IRIK, IDID, IDFE, IEID, IDIK, IKID, IDIR, IRID, YEYE, YEYK, YRYR, YEYK, YKYE, YEYR, YRYE, YKYR, YRYK, YDYD, YDYE, YEYD, YDYK, YKYD, YDYR, YRYD, Nle-E-Nle-E, Nle-K-Nle-K, Nle-R-Nle-R, Nle-E-Nle-K, Nle-K-Nle-E, Nle-E-Nle-R, Nle-R-Nle-E, Nle-K-Nle-R, Nle-R-Nle-K, Nle-D-Nle-D, Nle-D-Nle-E, Nle-E-Nle-D, Nle-D-Nle-K, Nle-K-Nle-D, Nle-D-Nle-R, and Nle-R-Nle-D.

In a most especially preferred embodiment, the peptidic macromonomer comprises a linkage introduced via a compound selected from, y-amino butyric acid (GABA), 5-aminovaleric acid (Ava), ε-amino caproic acid (ε-Ahx), or 3-aminopropionic acid β-ala); a functional peptide selected from RGD, hRGD, RGDWP and hRGDWP; and a self-assembling peptide selected from FEFKFEFK, FEFEFKFK, FDFKFDFK, FDFDFKFK, FEFRFEFR, FEFEFRFR, YDYKYDYK, YDYDYKYK, YEYRYEYR, YEYKYEYK, YEYEYKYK, WEWKWEWK, WEWEWKWK, WDWKWDWK, and WDWDWKWK.

In another most especially preferred embodiment, the peptidic polymerization initiator comprises a polymerization initiator introduced via mercapto propionic acid (Mpr); a functional peptide selected from RGD, hRGD, RGDWP and hRGDWP; and a self-assembling peptide selected from FEFKFEFK, FEFEFKFK, FDFKFDFK, FDFDFKFK, FEFRFEFR, FEFEFRFR, YDYKYDYK, YDYDYKYK, YEYRYEYR, YEYKYEYK, YEYEYKYK, WEWKWEWK, WEWEWKWK, WDWKWDWK, and WDWDWKWK.

Therefore, according to a more particularly preferred embodiment of the present invention, the thermo-responsive polymer is covalently bound with at least one peptide derivative selected from the group consisting of acrylate-GABA-hRGDWP-FEFEFKFK, acrylate-GABA-hRGDWP-FEFKFEFK, wherein GABA is γ-amino butyric acid; acrylate-ε-Ahx-hRGDWP-FEFEFKFK, acrylate-ε-Ahx-hRGDWP-FEFKFEFK, wherein ε-Ahx is ε-amino caproic acid; acrylate-β-ala-hRGDWP-FEFEFKFK, acrylate-β-ala-hRGDWP-FEFKFEFK, wherein β-ala is 3-aminopropionic acid; Mpr-hRGDWP-FEFEFKFK and Mpr-hRGDWP-FEFKFEFK, wherein Mpr is mercapto propionic acid; and combinations thereof. Another suitable example of peptide derivative is acrylate-Ava-hRGDWP-FEFEFKFK or acrylate-Ava-hRGDWP-FEFKFEFK, wherein Ava is 5-aminovaleric acid. According to a most preferred embodiment, the present thermo-responsive polymer is poly-(N-isopropylacrylamide) (PNIPAAm) or a copolymer thereof. In this most preferred embodiment, poly-(N-isopropylacrylamide) or copolymers thereof are preferably covalently bound with at least one peptide derivative as defined above, more particularly with at least one peptide derivative selected from the group consisting of acrylate-GABA-hRGDWP-FEFEFKFK, acrylate-GABA-hRGDWP-FEFKFEFK, wherein GABA is γ-amino butyric acid; acrylate-ε-Ahx-hRGDWP-FEFEFKFK, acrylate-ε-Ahx-hRGDWP-FEFKFEFK, wherein ε-Ahx is ε-amino caproic acid; acrylate-β-ala-hRGDWP-FEFEFKFK, acrylate-β-ala-hRGDWP-FEFKFEFK, wherein β-ala is 3-aminopropionic acid; Mpr-hRGDWP-FEFEFKFK and Mpr-hRGDWP-FEFKFEFK; and combinations thereof. Another suitable example of peptide derivative is acrylate-Ava-hRGDWP-FEFEFKFK or acrylate-Ava-hRGDWP-FEFKFEFK, wherein Ava is 5-aminovaleric acid.

The present polymers provide characteristics that can be varied by choice of monomer(s). An exemplary variation in the polymer properties is hydrophobicity/hydrophilicity balance in the monomers composition. In general, providing larger hydrophobic moieties on a thermo-responsive polymer decreases water swellablility. For example hydrogels made of isopropyl acrylamide are water swellable and possess small hydrophobic moieties (i.e. and isopropylgroup). The hydrophobic binding character of these gels is salt dependent. However, when the isopropyl group is replaced by a larger hydrophobic moiety, e.g., an octyl group, the gel loses some of its water swellablility.

Exemplary hydrophilic moieties are derived from monomers that include N-methacryloyl-tris(hydroxymethyl)methylamide, hydroxyethyl acrylamide, hydroxypropyl methacrylamide (HPMA), N-acrylamido-1-deoxysorbitol, hydroxyl-ethylmethacrylate, hydroxypropylactrylate, hydroxyphenyl methacrylate, 2-hydroxypropyl acrylate, 4-hydroxybutylmethactrylate, 2-methacryloxyethyl glucoside, poly(ethyleneglycol)monomethyl ether monomethacrylate,vinyl-4-hydroxybutyl ether, and derivatives thereof. Other suitable examples include acrylic acid (AA) and glycerol methacrylate. Preferred hydrophilic moieties are for instance derived from monomers that include a poly(oxyalkylene) group within their structure. Poly(ethylene glycol)containing monomers are also preferred. Hydroxypropylmethacrylamide (HPMA) is especially preferred, leading to copolymers PNIPAAm/HPMA. Other especially preferred copolymers are PNIPAAm/acrylic acid and PNIPAAm/glycerol methacrylate.

Further preferred hydrophobic moieties are derived from acrylamide monomers in which the amine nitrogen of the amide group is substituted with one or more alkyl residues. Exemplary hydrophobic moieties are derived from monomers selected from N-i sopropylacrylamide, N,N-dimethylacrylamide, N,N-diethyl(meth)acrylamide, N-methyl methacrylamide, N-ethylmethacrylamide, N-propylacrylamide, N-butylacrylamide, N-octyl (meth)acrylamide, N-dodecylmethacrylamide, N-octadecylacrylamide, propyl(meth)acrylate, decyl(meth)acrylate, stearyl(meth)acrylate, octyl-triphenylmethylacrylamide, butyl-triphenylmethylacrylamide, octadedcyl-triphenylmethylacrylamide, phenyl-triphenylmethylacrylamide, benzyl-triphenylmethylacrylamide, and derivatives thereof.

As indicated above, the thermo-responsive polymers covalently bound to the one or more peptides according to the invention are capable of providing a hydrogel suitable for cell and tissue culture providing, for example, improved cell adhesion and cell growth.

Accordingly, according to a second aspect, the present invention relates to compositions, preferably compositions for providing hydrogels, comprising the modified thermo-responsive polymers (i.e. covalently bound with a peptide) according to the invention.

The compositions according to the present invention, besides the present thermo-responsive polymers bound with a peptide, can comprise compounds suitable for cell culture such as nutrients, antibiotics, buffers, growth factors etc.

According to another aspect, the present invention relates to methods for preparing the present thermo-responsive polymers covalently bound with a peptide, the method comprises the step of reacting a mixture comprising at least thermo-responsive polymer monomers, or a thermo-responsive polymer, and peptides or peptide derivatives as defined above, under appropriate reaction conditions allowing covalent attachment of the peptides or peptide derivatives to the monomers or polymers.

According to a preferred embodiment of the above aspect of the present invention, the mixture comprises thermo-responsive polymer monomers and the appropriate reaction conditions further allow polymerization of the thermo-responsive polymer monomers.

Within the present context, the reaction conditions allowing covalent attachment of the peptides to the thermo-responsive polymer monomers and the conditions allowing polymerization of the monomers can be the same or similar, or they can be different. In other words, according the present invention, the present covalent coupling of the peptides to the thermo-responsive monomers can be performed after, before or simultaneous with the polymerization of the thermo-responsive monomers into thermo-responsive polymers.

Advantageously, the methods for preparing the present thermo-responsive polymers uses the peptidic macromonomers or the peptidic polymerization initiators as defined above.

The most preferred peptide derivatives according to the method of the present invention are peptide derivatives selected from the group consisting of acrylate-GABA-hRGDWP-FEFEFKFK, acrylate-GABA-hRGDWP-FEFKFEFK, wherein GABA is γ-amino butyric acid; acrylate-ε-Ahx-hRGDWP-FEFEFKFK, acrylate-ε-Ahx-hRGDWP-FEFKFEFK, wherein ε-Ahx is ε-amino caproic acid; acrylate-β-ala-hRGDWP-FEFEFKFK, acrylate-β-ala-hRGDWP-FEFKFEFK, wherein β-ala is 3-aminopropionic acid; Mpr-hRGDWP-FEFEFKFK and Mpr-hRGDWP-FEFKFEFK, wherein Mpr is mercapto propionic acid; and combinations thereof. Another most preferred example of peptide derivative is acrylate-Ava-hRGDWP-FEFEFKFK or acrylate-Ava-hRGDWP-FEFKFEFK, wherein Ava is 5-aminovaleric acid. More particularly in the method of the present invention, these peptide derivatives are attached covalently to poly-(N-isopropylacrylamide) or copolymers thereof.

According to yet another aspect, the present invention relates to peptide derivatives selected from the group consisting of acrylate-GABA-hRGDWP-FEFEFKFK, acrylate-GABA-hRGDWP-FEFKFEFK, wherein GABA is γ-amino butyric acid; acrylate-ε-Ahx-hRGDWP-FEFEFKFK, acrylate-ε-Ahx-hRGDWP-FEFKFEFK, wherein ε-Ahx is ε-amino caproic acid; Mpr-hRGDWP-FEFEFKFK, acrylate-β-ala-hRGDWP-FEFEFKFK, acrylate-β-ala-hRGDWP-FEFKFEFK, wherein β-ala is 3-aminopropionic acid; Mpr-hRGDWP-FEFEFKFK and Mpr-hRGDWP-FEFKFEFK, wherein Mpr is mercapto propionic acid; and combinations thereof. The present invention also relates to peptide derivatives selected from acrylate-Ava-hRGDWP-FEFEFKFK and acrylate-Ava-hRGDWP-FEFKFEFK, wherein Ava is 5-aminovaleric acid.

The present modified thermo-responsive polymers (i.e. covalently bound with a peptide), and compositions comprising the same are capable of providing hydrogels especially suitable for cell and tissue culture providing, for example, improved cell adhesion and cell growth

Accordingly, the present invention, according to still another aspect, is related to the use of the present thermo-responsive polymers covalently bound with a peptide or compositions according to the invention for the preparation of hydrogels, preferably hydrogels for cell culture.

The present use can comprise a method for preparing a hydrogel comprising the steps of:
a) adding at least water to the modified thermo-responsive polymer according to the invention (i.e. covalently bound with a peptide), or to the composition according to the invention;
b) optionally adding a further peptide that is able to self-assemble;
c) optionally adjusting the pH and/or the ionic strength of the resulting medium; and allowing the modified thermo-responsive polymer, with or without the further peptide that is able to self-assemble, to form a hydrogel.

Step a) of the method for preparing a hydrogel may further comprise adding at least one organic solvent to the modified thermo-responsive polymer of the invention or to the composition of the invention. Said organic solvent may be added prior, with or after the water, preferably prior the water. Said organic solvent is usually selected from polar aprotic solvents such as dimethyl sulfoxide (DMSO), dimethylformamide (DMF), dimethylacetamide (DMA) and N-methyl-2-pyrrolidone (NMP), taken alone or combined together.

In one embodiment, the adjustment of the pH is performed by adding a base, such as NaOH, or is performed by washing the modified thermoresponsive polymer with cell medium. The pH is preferably adjusted by washing the modified thermoresponsive polymer with cell culture medium, optionally comprising serum. The ionic strength of the medium can be adjusted by adding salts to the medium until a ionic strength is reached that is suitable for cell culturing, e.g. 150 mM. The pH adjustment and the ionic strength adjustment can be performed before or after the hydrogel is formed.

In one embodiment, the thermo-responsive polymer covalently bound with a peptide is suitable for providing a hydrogel providing improved cell adhesion and/or cell growth. Cells can adhere on the hydrogel at a temperature below the LCST of the thermo-responsive polymer constituent. The attachment can occur via the interaction of the cells with the functional peptide moiety. By increasing the temperature above the LCST, the thermo-responsive polymer constituent collapses and the functional peptide becomes blocked, since it is no longer exposed. This can induce a change in the interaction of the cells since the receptors of the cells can no longer interfere with the functional peptide. When the functional peptide comprises bioactive sequences that induce cell attachment, the increase of the temperature above the LCST induces the detachment of the cells, and facilitates harvesting of the cells.

The present hydrogel can be used for example for culturing cells, preferably fibroblast cells, chondrocyte cells or stem cells, or for tissue engineering.

For using a 2-dimensional cell culture system, the modified polymer of the invention is preferably in the form of a hydrogel. The pH of the gel can be adjusted by washing the gel with cell medium and/or by adding some salt. The cells are then seeded on the hydrogel and can grow to form a cell culture.

For using a 3-dimensional cell culture system, it is preferred that first the pH and ionic strength of the modified polymer of the invention are adjusted, and then the cells are added to the modified polymer. The mixture is then brought to conditions that allow the formation of the hydrogel. The cells can than grow in the hydrogel and form a 3-dimensional cell culture.

Should the disclosure of any patents, patent applications, and publications which are incorporated herein by reference conflict with the description of the present application to the extent that it might render a term unclear, the present description shall take precedence.

The present invention is further illustrated below without limiting the scope thereto.

### EXAMPLES

### Example 1

In the following, (h)RGD means that RGD, hRGD or a mixture thereof can be used.

### 1.1 Synthesis of the Protected Octapeptide

Octapeptide Phe-Glu-Phe-Lys-Phe-Glu-Phe-Lys (FEFKFEFK) can be synthesized as disclosed in A. Maslovskis et al., Macromol. Symp., 296, 248-253 (2010), on a ChemTech ACT 90 peptide synthesizer using N-methyl-2-pyrrolidone (NMP) as solvent, and standard solid phase peptide protocols.

Octapeptide can be also synthesized in a liquid phase approach (strategies Z/Boc/OtBu or Fmoc/Boc/OtBu). In this particular case, side protection groups remain on the sequence even during the deprotection of the protecting group on N-terminal position, thus leading to Z-Phe-Glu(OtBu)-Phe-Lys(Boc)-Phe-Glu(OtBu)-Phe-Lys(Boc)-OH.

### 1.2 Esterification of the Protected Octapeptide

This esterification step was performed according the literature: P. Jouin et al., J. Org. Chem., 54, 3, 617-626, 1989. 50 g of Z-Phe-Glu(OtBu)-Phe-Lys(Boc)-Phe-Glu(OtBu)-Phe-Lys(Boc)-OH (32 mmol) and 5.3 g of cesium carbonate were introduced in 500 ml of N,N-dimethylformamide (DMF). 5.5 ml of iodoethane (EtI) were added, and the solution was heated at 48° C. for 2 hours. After filtration of the salts and partial evaporation of DMF, the concentrate was poured into 500 ml of KHSO₄ 2.5%, filtrated, washed with water and finally with 500 ml warm ethanol. After drying under vacuum (45° C.), 47 g of a solid, corresponding to Z-Phe-Glu(OtBu)-Phe-Lys(Boc)-Phe-Glu(OtBu)-Phe-Lys(Boc)-OEt were obtained. Yield=84%.

### 1.3 Hydrogenolysis of the Protected Octapeptide Ethyl Ester

21.6 g of Z-Phe-Glu(OtBu)-Phe-Lys(Boc)-Phe-Glu(OtBu)-Phe-Lys(Boc)-OEt (13.6 mmol) were dissolved in 215 ml of N,N-dimethylformamide (DMA). After flushing the solution several times with nitrogen, 14.5 g of Pd/Si (2% weight) were added. Hydrogenolysis was initiated by the introduction of hydrogen. After 2 hours of reaction, the suspension was passed through a 0.45 μm filter and Pd/Si was washed by DMA. The gathered filtrates, corresponding to H-Phe-Glu(OtBu)-Phe-Lys(Boc)-Phe-Glu(OtBu)-Phe-Lys(Boc)-OEt, were used without further purification in the next steps. The yield was quantitative.

### Example 2

### Synthesis of Protected Mpr-hRGDWP

7.3 g of S-trityl (or triphenylmethyl) mercaptopropionyl homoarginyl glycine (Mpr(Trityl)-Har-Gly-OH) (12.0 mmol) were dissolved in 75 ml of N,N-dimethylformamide (DMF) containing 1 ml of pyridine. Once the solution cooled at −10±5° C., 1.6 g of pivaloyl chloride (PivCl) were added. After 5-10 min of activation, 6.3 g of O-t-butyl aspargyl tryptophanyl proline (Asp(OtBu)-Trp-Pro) (12.7 mmol) solubilized in 10 ml of DMF containing 6.1 g of N-trimethylsilylacetamide (TMA) were added. The reaction mixture was then brought back to room temperature.

After HPLC control of the completion of the reaction, 16.4 ml of water were added. After partial concentration, the concentrate diluted by 35 ml of methanol was poured into 155 ml of NaHCO₃ aqueous 2.5%. The precipitate was washed several times with water, and dried under vacuum. 10.6 g of an off-white product corresponding to Mpr(Trt)-Har-Gly-Asp(OtBu)-Trp-Pro-OH were obtained. Yield=87%.

### Example 3

### 3.1 Coupling of the Protected Mpr-hRGDWP And Octapeptide

13.9 g of Mpr(Trt)-Har-Gly-Asp(OtBu)-Trp-Pro-OH (13.2 mmol), 2.5 g of p-toluenesulfonic acid, and 6.2g of hydroxybenzotriazole (HOBt) were added to a solution of H-Phe-Glu(OtBu)-Phe-Lys(Boc)-Phe-Glu(OtBu)-Phe-Lys(Boc)-OEt (12 mmol) in N,N-dimethylformamide (DMA). Once a solution obtained, 2.7 g of 1-ethyl-3-(3-dimethylaminopropyl) carbodiimide hydrochloride (EDC) were added at room temperature. After stirring at least 8 hours, the reaction mixture was poured into 300 ml of KHSO₄ 2.5% aqueous. After filtration, the precipitate was washed three times by ethanol (270 ml), and dried under vacuum at 45° C. 26.3g of an off-white solid, corresponding to the sequence Mpr(Trt)-Har-Gly-Asp(OtBu)-Trp-Pro-Phe-Glu(OtBu)-Phe-Lys(Boc)-Phe-Glu(OtBu)-Phe-Lys(Boc)-OEt, were obtained. Yield=72%.

### 3.2 Final Deprotection of the Protected Mpr-hRGDWP-octapeptide

5 g of Mpr(Trt)-Har-Gly-Asp(OtBu)-Trp-Pro-Phe-Glu(OtBu)-Phe-Lys(Boc)-Phe-Glu(OtBu)-Phe-Lys(Boc)-OEt (1.9 mmol) were then introduced into a solution containing 100 ml of TFA, 100 ml of CH₂Cl₂, 9 ml of tri-isopropylsilane ((iPr)₃SiH), 2.2 ml of water and 2.2 ml of EtOH. After about 1 hour of reaction, the reaction mixture was poured into 200 ml of cold isopropyl ether (IPE). After filtration and washing several times by IPE, the peptide was dried under vacuum (45° C.). 3 g of off-white peptide were obtained, corresponding to Mpr-Har-Gly-Asp-Trp-Pro-Phe-Glu-Phe-Lys-Phe-Glu-Phe-Lys-OEt. Yield=88%.

In order to increase the purity of this sequence, preparative HPLC following by lyophilization can be used.

### Example 4

### Synthesis of Protected Mpr-RGDWP

### 4.1 Synthesis of Z-Arg-Gly-Asp(OtBu)-Trp-Pro-OH

3.4 g of Z-Arg-Gly-OH (10.0 mmol) were dissolved in 80 ml of a mixture dichloromethane (CH₂Cl₂)/N,N-dimethylacetamide (DMA) (1/1) containing 0.86 ml of pyridine. Once the solution cooled at −10±5° C., 1.3 g of pivaloyl chloride (PivCl) were added. After 5-10 min of activation, 5.21 g of Asp(OtBu)-Trp-Pro (10.6 mmol) solubilized in 0.3 ml of CH₂Cl₂ containing 5.29 g of N-trimethylsilylacetamide (TMA) were added. The reaction mixture was then brought back to room temperature.

After HPLC control of the completion of the reaction, 10 ml of water were added. After partial concentration, the concentrate diluted by 30 ml of methanol was poured into 140 ml of NaHCO₃ aqueous 2.5%. The precipitate was washed several times with water.

9.1 g of the resulting wet product, corresponding to Z-Arg-Gly-Asp(OtBu)-Trp-Pro-OH, were added to about 200 ml of a boiling mixture of acetonitrile/water/methanol (79/20/1 v/v). After solubilisation of the solid, the solution was progressively cooled down. During this cooling down step, 340 ml of NaHCO₃ aqueous 2.5% were poured. After apparition of a white solid, the suspension was further stirred at 0° C. for at least 10 h. After filtration and several washings by 100 ml of acetonitrile/water (1/2), the peptide was dried under vacuum (45° C.). 6 g of off-white peptide were obtained, corresponding to Z-Arg-Gly-Asp(OtBu)-Trp-Pro-OH (5% water content). Yield=70%.

### 4.2 Synthesis of H-Arg-Gly-Asp(OtBu)-Trp-Pro-OH

20.0 g of Z-Arg-Gly-Asp(OtBu)-Trp-Pro-OH (22.2 mmol) were dissolved in 240 ml of a mixture methanol/water (95/5) containing 1.85 ml of HCl 37% aqueous. After flushing the solution several times with nitrogen, 23.6 g of Pd/Si (2% weight) were added. Hydrogenolysis was initiated by the introduction of hydrogen. After 2 hours of reaction, the suspension was passed through a 0.45 μm filter and Pd/Si was washed by a mixture methanol/water (95/5). The gathered filtrates were concentrated under vacuum, and water was further replaced through azeotropic concentration by acetonitrile. The precipitate was filtrated, washed and dried under vacuum. 13.1 g of off-white powder, corresponding to H-Arg-Gly-Asp(OtBu)-Trp-Pro-OH.HCl, were obtained (1.8% water content). Yield=85%.

### 4.3 Synthesis of Mpr(Trt)-Arg-Gly-Asp(OtBu)-Trp-Pro-OH

8.08 g of H-Arg-Gly-Asp(OtBu)-Trp-Pro-OH.HCl (11 mmol) were added at 45° C. to 150 ml of a mixture water/dioxane (1/2) at a pH ranging from 8.0 and 8.5 (KHCO₃ buffer). 5 g of Mpr(Trt)OSu (10.4 mmol), divided into 5 equivalent fractions, were added at regular interval to the above solution. After control of the completion of the reaction by HPLC, the reaction mixture was poured into 400 ml of water and the dioxane fraction was evaporated under vacuum. After filtration of the suspension, the wet solid was treated according the protocol described in example 4.1, to lead to Mpr(Trt)-Arg-Gly-Asp(OtBu)-Trp-Pro-OH (protected Mpr-RGDWP). Yield=74%.

### Example 5

### 5.1 Coupling of the Protected Mpr-RGDWP And Octapeptide

The Mpr(Trt)-Arg-Gly-Asp(OtBu)-Trp-Pro-OH was then coupled to H-Phe-Glu(OtBu)-Phe-Lys(Boc)-Phe-Glu(OtBu)-Phe-Lys(Boc)-OEt according the protocol used in Example 3.2. Yield=74%.

### 5.2 Final Deprotection of the Protected Mpr-RGDWP-octapeptide

The protected Mpr-RGDWP-ocapeptide was then deprotected according the protocol used in Example 3.2 for the deprotection of the protected Mpr-hRGDWP-octapeptide. Yield=87%.

In order to increase the purity of this sequence, preparative HPLC following by lyophilization can be used.

### Example 6

### Synthesis of Peptidic Macromonomer

0.9 g of methacrylic acid (10 mmol), 1.35g of hydroxybenzotriazole (HOBt), and 2.0 g of EDC.HCl were added to a solution of DMA containing H-Phe-Glu(OtBu)-Phe-Lys(Boc)-Phe-Glu(OtBu)-Phe-Lys(Boc)-OEt (15% weight/volume, 10 mmol). After HPLC control of the completion of the reaction, the reaction mixture was added dropwise to a KHSO₄ aqueous solution (fivefold volume of the reaction mixture). After filtration, the precipitate was washed first with water (one third of the volume of precipitation), and then by a acetonitrile/water (90/10) mixture. After drying under vacuum, 14 g of macromonomer methacrylamide-Phe-Glu(OtBu)-Phe-Lys(Boc)-Phe-Glu(OtBu)-Phe-Lys(Boc)-OEt were obtained. Yield=85%.

The protected macromonomer was then deprotected according the protocol used in Example 3.2 for the deprotection of the protected Mpr(Trt)hRGDWP-octapeptide. Yield=92%.

### Example 7

### Synthesis of the Modified Thermo-Responsive Polymer

### 7.1 Protocol I

6 g of N-isopropylacrylamide (NIPAAM, 53 mmol), 82 mg of azo-iso-butyronitrile (AIBN, 0.5 mmol) and 90 mg of Mpr-Har-Gly-Asp-Trp-Pro-(Phe-Glu-Phe-Lys)2-OEt (0.33 mmol) were dissolved in 80 ml N,N-dimethylformamide (DMA). The reaction mixture was stirred at 65° C. for 24 h under N₂. The reaction mixture was subsequently cooled to room temperature and the reaction mixture was concentrated up to 20 g. The polymer was obtained by pouring the concentrated solution into cold methyl t-butyl ether (MTBE). After washing several times with MTBE, the solid was dried under vacuum (45° C.). 2.2 g of yellow solid, corresponding to the modified thermo-responsive polymer (pNIPAAM-hRGDWP-FEFKFEFK), were obtained.

The resulting dry solid was diluted to 500 mL with deionised water and dialyzed against water for 5 days using tubing with 3500 g/mol molecular weight cut-off to remove short polymer chains and any unreacted reagents. The resulting solution was lyophilized to give a white powder with a yield of 95%.

### 7.2 Protocol II

Starting from N-isopropylacrylamide, azo-iso-butyronitrile, and peptidic macromonomer (ratio 1 equivalent macromonomer for 10 equivalent NIPAAM or comonomer), the same protocol as described above was applied.

### Example 8

### Hydrogel Preparation

16.3 mg of octapeptide and 11.4 mg of PNIPAAM-hRGD-octapeptide (80/20 octapeptide/octopeptide-(h)RGD-PNIPAAm molar ration) were dissolved in 1 ml distilled water at 90° C. for 3 hours. On cooling the samples are transferred in the cell culture well plate and incubated at 37° C. for 12 hours. The samples are then washed over 20 minutes with cell culture medium (DMEM Gibco, Invitogen) by changing the medium over the gel 6 times. The samples are placed back in the incubator at 37° C. overnight and washes are repeated the next day. The samples were placed again overnight in the incubator and the next day cell are seeded on the surface of the gels by adding 200 μl of medium with suspended cells (5×104 cells Human Dermal Fibriblast/well) on top of the surface of the gel followed by another 100 μl of fresh medium. Medium on the top of the gels is changed every day during cell culture experiments.

1. A thermo-responsive polymer covalently bound with at least one peptide, wherein the peptide comprises a peptide moiety that is able to self-assemble and a functional peptide moiety comprising a bioactive sequence.

2. The polymer according to claim 1, wherein the bioactive sequence of the functional peptide moiety is a cell adhesion providing amino acid sequence.

3. The polymer according to claim 1, wherein the at least one peptide is covalently bound with the thermo-responsive polymer through a linkage selected from the group consisting of thioether linkage, amino linkage, amido linkage, ester linkage, and ether linkage.

4. The polymer according to claim 3, wherein the linkage is
a thioether linkage, according to the formula:
—S—(CH2)ₓ—[C(O)]_{y}—
wherein x is 1-10; y is 0 or 1;
an amino linkage, according to the formula:
—NH—(CH₂)ₓ—[C(O)]_{y}—
wherein x is 0-10; y is 0 or 1;
an amido linkage, according to the formula:
—C(O)—NH—(CH₂)ₓ—[C(O)]_{y}—
wherein x is 0-10; y is 0 or 1;
an ester linkage, according to the formula:
—C(O)—O—(CH₂)ₓ—[C(O)]_{y}—
wherein x is 1-10; y is 0 or 1;
an ether linkage, according to the formula:
—O—(CH₂)ₓ—[C(O)]_{y}—
wherein x is 0-10; y is 0 or 1.

5. The polymer according to claim 1, wherein said peptide moiety that is able to self-assemble is self-assembling in a β-sheet, a coiled coil a-helix structure, a peptide triple helix structure, or combinations thereof.

6. The polymer according to claim 1, wherein said peptide moiety that is able to self-assemble into a β-sheet, and wherein said peptide moiety is an octapeptide moiety comprising alternating hydrophobic and charged amino acids.

7. The polymer according to claim 19, wherein the peptide moiety that is able to self-assemble into a β-sheet is selected from the group consisting of FEFKFEFK, FEFEFKFK, FDFKFDFK, FDFDFKFK, FEFRFEFR, FEFEFRFR, YDYKYDYK, YDYDYKYK, YEYRYEYR, YEYKYEYK, YEYEYKYK, WEWKWEWK, WEWEWKWK, WDWKWDWK, and WDWDWKWK.

8. The polymer according to claim 1, wherein the thermo-responsive polymer is covalently bound with the at least one peptide through a terminus of the functional peptide moiety.

9. The polymer according to claim 1, wherein the thermo-responsive polymer is covalently bound with at least one peptide derivative selected from the group consisting of acrylate-GABA-hRGDWP-FEFEFKFK; acrylate-GABA-hRGDWP-FEFKFEFK, wherein GABA is γ-amino butyric acid; acrylate-Ava-hRGDWP-FEFEFKFK; acrylate-Ava-hRGDWP-FEFKFEFK, wherein Ava is 5-aminovaleric acid; acrylate-ε-Ahx-hRGDWP-FEFEFKFK; acrylate-ε-Ahx-hRGDWP-FEFKFEFK, wherein ε-Ahx is ε-amino caproic acid; acrylate-β-ala-hRGDWP-FEFEFKFK; acrylate-β-ala-hRGDWP-FEFKFEFK, wherein β-ala is 3-aminopropionic acid; Mpr-hRGDWP-FEFEFKFK; Mpr-hRGDWP-FEFKFEFK, wherein Mpr is mercapto propionic acid; and combinations thereof.

10. The polymer according to claim 1, wherein the thermo-responsive polymer is poly-(N-isopropylacrylamide) or a copolymer thereof.

11. A composition comprising the thermo-responsive polymer according to claim 1.

12. A peptide derivative selected from the group consisting of acrylate-GABA-hRGDWP-FEFEFKFK; acrylate-GABA-hRGDWP-FEFKFEFK, wherein GABA is γ-amino butyric acid; acrylate-Ava-hRGDWP-FEFEFKFK; acrylate-Ava-hRGDWP-FEFKFEFK, wherein Ava is 5-aminovaleric acid; acrylate-ε-Ahx-hRGDWP-FEFEFKFK; acrylate-ε-Ahx-hRGDWP-FEFKFEFK, wherein ε-Ahx is ε-amino caproic acid; acrylate-β-ala-hRGDWP-FEFEFKFK; acrylate-β-ala-hRGDWP-FEFKFEFK, wherein β-ala is 3-aminopropionic acid; Mpr-hRGDWP-FEFEFKFK; and Mpr-hRGDWP-FEFKFEFK, wherein Mpr is mercapto propionic acid.

13. A method for preparing the thermo-responsive polymer according to claim 1, comprising the step of reacting a mixture comprising thermo-responsive polymer monomers or a thermo-responsive polymer, and peptides or peptide derivatives, under appropriate reaction conditions allowing covalent attachment of the peptides or peptide derivatives to the monomers or the polymer;
wherein the peptides comprise a peptide moiety that is able to self-assemble and a functional peptide moiety comprising a bioactive sequence; and
wherein the peptide derivatives are selected from the group consisting of acrylate-GABA-hRGDWP-FEFEFKFK; acrylate-GABA-hRGDWP-FEFKFEFK, wherein GABA is γ-amino butyric acid; acrylate-Ava-hRGDWP-FEFEFKFK; acrylate-Ava-hRGDWP-FEFKFEFK, wherein Ava is 5-aminovaleric acid; acrylate-ε-Ahx-hRGDWP-FEFEFKFK; acrylate-ε-Ahx-hRGDWP-FEFKFEFK, wherein ε-Ahx is ε-amino caproic acid; acrylate-β-ala-hRGDWP-FEFEFKFK; acrylate-β-ala-hRGDWP-FEFKFEFK, wherein β-ala is 3-aminopropionic acid; Mpr-hRGDWP-FEFEFKFK; and Mpr-hRGDWP-FEFKFEFK, wherein Mpr is mercapto propionic acid.

14. The method according to claim 13, wherein the mixture comprises thermo-responsive polymer monomers, and wherein the appropriate reaction conditions further allow polymerization of the thermo-responsive polymer monomers.

15. The method according to claim 14, wherein the thermo-responsive polymer monomers are N-isopropylacrylamide, or the thermo-responsive polymers are poly(N-isopropylacrylamide) or copolymers thereof.

16. A method for the preparation of hydrogels, comprising using the thermo-responsive polymer according to claim 1.

17. The polymer according to claim 2, wherein the bioactive sequence of the functional peptide moiety comprises one or more sequences selected from the group consisting of Arg-Gly-Asp (RGD), Har-Gly-Asp (Har-GD or hRGD), RGDS, GRGDS, GRGDY, GRGDSY, GRGDF, YGRGD, GRGDSY, GRGDSP, GRGDSPK, YRGDS, GRGETP, GRGESP, GRGDTP, GRGDSPK, GRGDSP, GRGDK, GRADSPK, GGGGRGDS, GRGDSP, RGDYK, RGDFK,LDV, REDV, RGDV, LRGDN, IKVAV, YIGSR, PDSGR, RNAIEIIKDA, RGDT, DGEA, VTXG, GHK, QHREDGS, Arg-Gly-Asp-Trp-Pro (RGDWP), Har-Gly-Asp-Trp-Pro (Har-GDWP or hRGDWP), GRGDSY, QHREDGS, SDKP, (PPG)_{z}, (PEG)_{z}, (PDG)_{z}, (PKG)_{z}, (PRG)_{z} where z is 1-50, analogues thereof, and combinations thereof.

18. The polymer according to claim 17, wherein the bioactive sequence of the functional peptide moiety comprises RGDWP or hRGDWP sequences.

19. The polymer according to claim 6, wherein the octapeptide moiety is formed by the combination of two sequences selected independently from the group consisting of FEFE, FEFK, FEFD, FEFR, FRFR, FRFK, FRFE, FRFD, FKFE, FDFK, FKFR, FKFD, FDFD, FDFE, FDFR, FDFK, WEWE, WEWK, WRWR, WEWK, WKWE, WEWR, WRWE, WKWR, WRWK, WDWD, WDWE, WEWD, WDWK, WKWD, WDWR, WRWD, IEIE, IEIK, IRIR, IEIK, IKIE, IEIR, IRIE, IKIR, IRIK, IDID, IDFE, IEID, IDIK, IKID, IDIR, IRID, YEYE, YEYK, YRYR, YEYK, YKYE, YEYR, YRYE, YKYR, YRYK, YDYD, YDYE, YEYD, YDYK, YKYD, YDYR, YRYD, Nle-E-Nle-E, Nle-K-Nle-K, Nle-R-Nle-R, Nle-E-Nle-K, Nle-K-Nle-E, Nle-E-Nle-R, Nle-R-Nle-E, Nle-K-Nle-R, Nle-R-Nle-K, Nle-D-Nle-D, Nle-D-Nle-E, Nle-E-Nle-D, Nle-D-Nle-K, Nle-K-Nle-D, Nle-D-Nle-R, and Nle-R-Nle-D.

20. The polymer according to claim 7, wherein the peptide moiety that is able to self-assemble into a β-sheet is selected from the group consisting of FEFKFEFK and FEFEFKFK.


SEQUENCE LISTING (194 sequences)

SEQ ID NO: 1 - protein, 4 aa, Artificial Sequence
  Synthetic peptide
FEFE

SEQ ID NO: 2 - protein, 4 aa, Artificial Sequence
  Synthetic peptide
FEFK

SEQ ID NO: 3 - protein, 4 aa, Artificial Sequence
  Synthetic peptide
FEFD

SEQ ID NO: 4 - protein, 4 aa, Artificial Sequence
  Synthetic peptide
FEFR

SEQ ID NO: 5 - protein, 4 aa, Artificial Sequence
  Synthetic peptide
FRFR

SEQ ID NO: 6 - protein, 4 aa, Artificial Sequence
  Synthetic peptide
FRFK

SEQ ID NO: 7 - protein, 4 aa, Artificial Sequence
  Synthetic peptide
FRFE

SEQ ID NO: 8 - protein, 4 aa, Artificial Sequence
  Synthetic peptide
FRFD

SEQ ID NO: 9 - protein, 4 aa, Artificial Sequence
  Synthetic peptide
FKFE

SEQ ID NO: 10 - protein, 4 aa, Artificial Sequence
  Synthetic peptide
FKFK

SEQ ID NO: 11 - protein, 4 aa, Artificial Sequence
  Synthetic peptide
FKFR

SEQ ID NO: 12 - protein, 4 aa, Artificial Sequence
  Synthetic peptide
FKFD

SEQ ID NO: 13 - protein, 4 aa, Artificial Sequence
  Synthetic peptide
FDFD

SEQ ID NO: 14 - protein, 4 aa, Artificial Sequence
  Synthetic peptide
FDFE

SEQ ID NO: 15 - protein, 4 aa, Artificial Sequence
  Synthetic peptide
FDFR

SEQ ID NO: 16 - protein, 4 aa, Artificial Sequence
  Synthetic peptide
FDFK

SEQ ID NO: 17 - protein, 4 aa, Artificial Sequence
  Synthetic peptide
WEWE

SEQ ID NO: 18 - protein, 4 aa, Artificial Sequence
  Synthetic peptide
WEWK

SEQ ID NO: 19 - protein, 4 aa, Artificial Sequence
  Synthetic peptide
WRWR

SEQ ID NO: 20 - protein, 4 aa, Artificial Sequence
  Synthetic peptide
WEWK

SEQ ID NO: 21 - protein, 4 aa, Artificial Sequence
  Synthetic peptide
WKWE

SEQ ID NO: 22 - protein, 4 aa, Artificial Sequence
  Synthetic peptide
WEWR

SEQ ID NO: 23 - protein, 4 aa, Artificial Sequence
  Synthetic peptide
WRWE

SEQ ID NO: 24 - protein, 4 aa, Artificial Sequence
  Synthetic peptide
WKWR

SEQ ID NO: 25 - protein, 4 aa, Artificial Sequence
  Synthetic peptide
WRWK

SEQ ID NO: 26 - protein, 4 aa, Artificial Sequence
  Synthetic peptide
WDWD

SEQ ID NO: 27 - protein, 4 aa, Artificial Sequence
  Synthetic peptide
WDWE

SEQ ID NO: 28 - protein, 4 aa, Artificial Sequence
  Synthetic peptide
WEWD

SEQ ID NO: 29 - protein, 4 aa, Artificial Sequence
  Synthetic peptide
WDWK

SEQ ID NO: 30 - protein, 4 aa, Artificial Sequence
  Synthetic peptide
WKWD

SEQ ID NO: 31 - protein, 4 aa, Artificial Sequence
  Synthetic peptide
WDWR

SEQ ID NO: 32 - protein, 4 aa, Artificial Sequence
  Synthetic peptide
WRWD

SEQ ID NO: 33 - protein, 4 aa, Artificial Sequence
  Synthetic peptide
IEIE

SEQ ID NO: 34 - protein, 4 aa, Artificial Sequence
  Synthetic peptide
IEIK

SEQ ID NO: 35 - protein, 4 aa, Artificial Sequence
  Synthetic peptide
IRIR

SEQ ID NO: 36 - protein, 4 aa, Artificial Sequence
  Synthetic peptide
IEIK

SEQ ID NO: 37 - protein, 4 aa, Artificial Sequence
  Synthetic peptide
IKIE

SEQ ID NO: 38 - protein, 4 aa, Artificial Sequence
  Synthetic peptide
IEIR

SEQ ID NO: 39 - protein, 4 aa, Artificial Sequence
  Synthetic peptide
IRIE

SEQ ID NO: 40 - protein, 4 aa, Artificial Sequence
  Synthetic peptide
IKIR

SEQ ID NO: 41 - protein, 4 aa, Artificial Sequence
  Synthetic peptide
IRIK

SEQ ID NO: 42 - protein, 4 aa, Artificial Sequence
  Synthetic peptide
IDID

SEQ ID NO: 43 - protein, 4 aa, Artificial Sequence
  Synthetic peptide
IDFE

SEQ ID NO: 44 - protein, 4 aa, Artificial Sequence
  Synthetic peptide
IEID

SEQ ID NO: 45 - protein, 4 aa, Artificial Sequence
  Synthetic peptide
IDIK

SEQ ID NO: 46 - protein, 4 aa, Artificial Sequence
  Synthetic peptide
IKID

SEQ ID NO: 47 - protein, 4 aa, Artificial Sequence
  Synthetic peptide
IDIR

SEQ ID NO: 48 - protein, 4 aa, Artificial Sequence
  Synthetic peptide
IRID

SEQ ID NO: 49 - protein, 4 aa, Artificial Sequence
  Synthetic peptide
YEYE

SEQ ID NO: 50 - protein, 4 aa, Artificial Sequence
  Synthetic peptide
YEYK

SEQ ID NO: 51 - protein, 4 aa, Artificial Sequence
  Synthetic peptide
YRYR

SEQ ID NO: 52 - protein, 4 aa, Artificial Sequence
  Synthetic peptide
YEYK

SEQ ID NO: 53 - protein, 4 aa, Artificial Sequence
  Synthetic peptide
YKYE

SEQ ID NO: 54 - protein, 4 aa, Artificial Sequence
  Synthetic peptide
YEYR

SEQ ID NO: 55 - protein, 4 aa, Artificial Sequence
  Synthetic peptide
YRYE

SEQ ID NO: 56 - protein, 4 aa, Artificial Sequence
  Synthetic peptide
YKYR

SEQ ID NO: 57 - protein, 4 aa, Artificial Sequence
  Synthetic peptide
YRYK

SEQ ID NO: 58 - protein, 4 aa, Artificial Sequence
  Synthetic peptide
YDYD

SEQ ID NO: 59 - protein, 4 aa, Artificial Sequence
  Synthetic peptide
YDYE

SEQ ID NO: 60 - protein, 4 aa, Artificial Sequence
  Synthetic peptide
YEYD

SEQ ID NO: 61 - protein, 4 aa, Artificial Sequence
  Synthetic peptide
YDYK

SEQ ID NO: 62 - protein, 4 aa, Artificial Sequence
  Synthetic peptide
YKYD

SEQ ID NO: 63 - protein, 4 aa, Artificial Sequence
  Synthetic peptide
YDYR

SEQ ID NO: 64 - protein, 4 aa, Artificial Sequence
  Synthetic peptide
YRYD

SEQ ID NO: 65 - protein, 4 aa, Artificial Sequence
  Synthetic peptide
XEXE

SEQ ID NO: 66 - protein, 4 aa, Artificial Sequence
  Synthetic peptide
XKXK

SEQ ID NO: 67 - protein, 4 aa, Artificial Sequence
  Synthetic peptide
XRXR

SEQ ID NO: 68 - protein, 4 aa, Artificial Sequence
  Synthetic peptide
XEXK

SEQ ID NO: 69 - protein, 4 aa, Artificial Sequence
  Synthetic peptide
XKXE

SEQ ID NO: 70 - protein, 4 aa, Artificial Sequence
  Synthetic peptide
XEXR

SEQ ID NO: 71 - protein, 4 aa, Artificial Sequence
  Synthetic peptide
XRXE

SEQ ID NO: 72 - protein, 4 aa, Artificial Sequence
  Synthetic peptide
XKXR

SEQ ID NO: 73 - protein, 4 aa, Artificial Sequence
  Synthetic peptide
XRXK

SEQ ID NO: 74 - protein, 4 aa, Artificial Sequence
  Synthetic peptide
XDXD

SEQ ID NO: 75 - protein, 4 aa, Artificial Sequence
  Synthetic peptide
XDXE

SEQ ID NO: 76 - protein, 4 aa, Artificial Sequence
  Synthetic peptide
XEXD

SEQ ID NO: 77 - protein, 4 aa, Artificial Sequence
  Synthetic peptide
XDXK

SEQ ID NO: 78 - protein, 4 aa, Artificial Sequence
  Synthetic peptide
XKXD

SEQ ID NO: 79 - protein, 4 aa, Artificial Sequence
  Synthetic peptide
XDXR

SEQ ID NO: 80 - protein, 4 aa, Artificial Sequence
  Synthetic peptide
XRXD

SEQ ID NO: 81 - protein, 8 aa, Artificial Sequence
  Synthetic peptide
FEFKFEFK

SEQ ID NO: 82 - protein, 8 aa, Artificial Sequence
  Synthetic peptide
FEFEFKFK

SEQ ID NO: 83 - protein, 8 aa, Artificial
  Synthetic peptide
FDFKFDFK

SEQ ID NO: 84 - protein, 8 aa, Artificial
  Synthetic peptide
FDFDFKFK

SEQ ID NO: 85 - protein, 8 aa, Artificial
  Synthetic peptide
FEFRFEFR

SEQ ID NO: 86 - protein, 8 aa, Artificial
  Synthetic peptide
FEFEFRFR

SEQ ID NO: 87 - protein, 8 aa, Artificial
  Synthetic peptide
YDYKYDYK

SEQ ID NO: 88 - protein, 8 aa, Artificial
  Synthetic peptide
YDYDYKYK

SEQ ID NO: 89 - protein, 8 aa, Artificial
  Synthetic peptide
YEYRYEYR

SEQ ID NO: 90 - protein, 8 aa, Artificial
  Synthetic peptide
YEYKYEYK

SEQ ID NO: 91 - protein, 8 aa, Artificial
  Synthetic peptide
YEYEYKYK

SEQ ID NO: 92 - protein, 8 aa, Artificial
  Synthetic peptide
WEWKWEWK

SEQ ID NO: 93 - protein, 8 aa, Artificial
  Synthetic peptide
WEWEWKWK

SEQ ID NO: 94 - protein, 8 aa, Artificial
  Synthetic peptide
WDWKWDWK

SEQ ID NO: 95 - protein, 8 aa, Artificial
  Synthetic peptide
WDWDWKWK

SEQ ID NO: 96 - protein, 4 aa, Artificial
  Synthetic peptide
GRGD

SEQ ID NO: 97 - protein, 4 aa, Artificial
  Synthetic peptide
GXGD

SEQ ID NO: 98 - protein, 4 aa, Artificial
  Synthetic peptide
YXGD

SEQ ID NO: 99 - protein, 5 aa, Artificial
  Synthetic peptide
YGRGD

SEQ ID NO: 100 - protein, 5 aa, Artificial
  Synthetic peptide
YGXGD

SEQ ID NO: 101 - protein, 7 aa, Artificial
  Synthetic peptide
GGGGRGD

SEQ ID NO: 102 - protein, 7 aa, Artificial
  Synthetic peptide
GGGGXGD

SEQ ID NO: 103 - protein, 4 aa, Artificial
  Synthetic peptide
XRGD

SEQ ID NO: 104 - protein, 4 aa, Artificial
  Synthetic peptide
XXGD

SEQ ID NO: 105 - protein, 4 aa, Artificial
  Synthetic peptide
XRGD

SEQ ID NO: 106 - protein, 4 aa, Artificial
  Synthetic peptide
XXGD

SEQ ID NO: 107 - protein, 4 aa, Artificial
  Synthetic peptide
XRGD

SEQ ID NO: 108 - protein, 4 aa, Artificial
  Synthetic peptide
XXGD

SEQ ID NO: 109 - protein, 4 aa, Artificial Sequence
  Synthetic peptide
RGDS

SEQ ID NO: 110 - protein, 4 aa, Artificial Sequence
  Synthetic peptide
XGDS

SEQ ID NO: 111 - protein, 4 aa, Artificial
  Synthetic peptide
RGDY

SEQ ID NO: 112 - protein, 4 aa, Artificial
  Synthetic peptide
XGDY

SEQ ID NO: 113 - protein, 4 aa, Artificial
  Synthetic peptide
RGDF

SEQ ID NO: 114 - protein, 4 aa, Artificial
  Synthetic peptide
XGDF

SEQ ID NO: 115 - protein, 4 aa, Artificial
  Synthetic peptide
RGDK

SEQ ID NO: 116 - protein, 4 aa, Artificial
  Synthetic peptide
XGDK

SEQ ID NO: 117 - protein, 4 aa, Artificial
  Synthetic peptide
RGDV

SEQ ID NO: 118 - protein, 4 aa, Artificial
  Synthetic peptide
XGDV

SEQ ID NO: 119 - protein, 4 aa, Artificial
  Synthetic peptide
RGDT

SEQ ID NO: 120 - protein, 4 aa, Artificial
  Synthetic peptide
XGDT

SEQ ID NO: 121 - protein, 5 aa, Artificial
  Synthetic peptide
RGDWP

SEQ ID NO: 122 - protein, 5 aa, Artificial
  Synthetic peptide
XGDWP

SEQ ID NO: 123 - protein, 5 aa, Artificial
  Synthetic peptide
RGDYK

SEQ ID NO: 124 - protein, 5 aa, Artificial
  Synthetic peptide
XGDYK

SEQ ID NO: 125 - protein, 5 aa, Artificial
  Synthetic peptide
RGDFK

SEQ ID NO: 126 - protein, 5 aa, Artificial
  Synthetic peptide
XGDFK

SEQ ID NO: 127 - protein, 5 aa, Artificial
  Synthetic peptide
RGDSP

SEQ ID NO: 128 - protein, 5 aa, Artificial
  Synthetic peptide
XGDSP

SEQ ID NO: 129 - protein, 6 aa, Artificial
  Synthetic peptide
RGDSPK

SEQ ID NO: 130 - protein, 6 aa, Artificial
  Synthetic peptide
XGDSPK

SEQ ID NO: 131 - protein, 5 aa, Artificial
  Synthetic peptide
RGDSY

SEQ ID NO: 132 - protein, 5 aa, Artificial
  Synthetic peptide
XGDSY

SEQ ID NO: 133 - protein, 5 aa, Artificial
  Synthetic peptide
RGDNP

SEQ ID NO: 134 - protein, 5 aa, Artificial
  Synthetic peptide
XGDNP

SEQ ID NO: 135 - protein, 5 aa, Artificial
  Synthetic peptide
RGDTP

SEQ ID NO: 136 - protein, 5 aa, Artificial
  Synthetic peptide
XGDTP

SEQ ID NO: 137 - protein, 5 aa, Artificial
  Synthetic peptide
RGDSP

SEQ ID NO: 138 - protein, 5 aa, Artificial
  Synthetic peptide
XGDSP

SEQ ID NO: 139 - protein, 5 aa, Artificial
  Synthetic peptide
GRGDS

SEQ ID NO: 140 - protein, 5 aa, Artificial
  Synthetic peptide
GXGDS

SEQ ID NO: 141 - protein, 5 aa, Artificial
  Synthetic peptide
GRGDY

SEQ ID NO: 142 - protein, 5 aa, Artificial
  Synthetic peptide
GXGDY

SEQ ID NO: 143 - protein, 5 aa, Artificial
  Synthetic peptide
GRGDF

SEQ ID NO: 144 - protein, 5 aa, Artificial
  Synthetic peptide
GXGDF

SEQ ID NO: 145 - protein, 6 aa, Artificial
  Synthetic peptide
GRGDSY

SEQ ID NO: 146 - protein, 6 aa, Artificial
  Synthetic peptide
GXGDSY

SEQ ID NO: 147 - protein, 6 aa, Artificial
  Synthetic peptide
GRGDSP

SEQ ID NO: 148 - protein, 6 aa, Artificial
  Synthetic peptide
GXGDSP

SEQ ID NO: 149 - protein, 7 aa, Artificial
  Synthetic peptide
GRGDSPK

SEQ ID NO: 150 - protein, 7 aa, Artificial
  Synthetic peptide
GXGDSPK

SEQ ID NO: 151 - protein, 5 aa, Artificial
  Synthetic peptide
YRGDS

SEQ ID NO: 152 - protein, 5 aa, Artificial
  Synthetic peptide
YXGDS

SEQ ID NO: 153 - protein, 6 aa, Artificial
  Synthetic peptide
GRGDTP

SEQ ID NO: 154 - protein, 6 aa, Artificial
  Synthetic peptide
GXGDTP

SEQ ID NO: 155 - protein, 7 aa, Artificial
  Synthetic peptide
GRGDSPK

SEQ ID NO: 156 - protein, 7 aa, Artificial
  Synthetic peptide
GXGDSPK

SEQ ID NO: 157 - protein, 5 aa, Artificial
  Synthetic peptide
GRGDK

SEQ ID NO: 158 - protein, 5 aa, Artificial
  Synthetic peptide
GXGDK

SEQ ID NO: 159 - protein, 8 aa, Artificial
  Synthetic peptide
GGGGRGDS

SEQ ID NO: 160 - protein, 8 aa, Artificial
  Synthetic peptide
GGGGXGDS

SEQ ID NO: 161 - protein, 6 aa, Artificial
  Synthetic peptide
GRGDNP

SEQ ID NO: 162 - protein, 6 aa, Artificial
  Synthetic peptide
GXGDNP

SEQ ID NO: 163 - protein, 6 aa, Artificial
  Synthetic peptide
GRGETP

SEQ ID NO: 164 - protein, 6 aa, Artificial
  Synthetic peptide
GRGESP

SEQ ID NO: 165 - protein, 7 aa, Artificial
  Synthetic peptide
GRADSPK

SEQ ID NO: 166 - protein, 4 aa, Artificial Sequence
  Synthetic peptide
REDV

SEQ ID NO: 167 - protein, 5 aa, Artificial
  Synthetic peptide
LRGDN

SEQ ID NO: 168 - protein, 5 aa, Artificial
  Synthetic peptide
IKVAV

SEQ ID NO: 169 - protein, 5 aa, Artificial
  Synthetic peptide
YIGSR

SEQ ID NO: 170 - protein, 5 aa, Artificial
  Synthetic peptide
PDSGR

SEQ ID NO: 171 - protein, 10 aa, Artificial
  Synthetic peptide
RNAIEIIKDA

SEQ ID NO: 172 - protein, 4 aa, Artificial
  Synthetic peptide
DGEA

SEQ ID NO: 173 - protein, 4 aa, Artificial
  Synthetic peptide
VTXG

SEQ ID NO: 174 - protein, 7 aa, Artificial
  Synthetic peptide
QHREDGS

SEQ ID NO: 175 - protein, 4 aa, Artificial
  Synthetic peptide
SDKP

SEQ ID NO: 176 - protein, 13 aa, Artificial Sequence
  Synthetic peptide
XGDWPFEFEFKFK

SEQ ID NO: 177 - protein, 13 aa, Artificial Sequence
  Synthetic peptide
XGDWPFEFKFEFK

SEQ ID NO: 178 - protein, 13 aa, Artificial Sequence
  Synthetic peptide
XGDWPFEFEFKFK

SEQ ID NO: 179 - protein, 13 aa, Artificial Sequence
  Synthetic peptide
XGDWPFEFKFEFK

SEQ ID NO: 180 - protein, 14 aa, Artificial Sequence
  Synthetic peptide
XXGDWPFEFEFKFK

SEQ ID NO: 181 - protein, 14 aa, Artificial Sequence
  Synthetic peptide
XXGDWPFEFKFEFK

SEQ ID NO: 182 - protein, 13 aa, Artificial Sequence
  Synthetic peptide
XGDWPFEFEFKFK

SEQ ID NO: 183 - protein, 13 aa, Artificial Sequence
  Synthetic peptide
XGDWPFEFKFEFK

SEQ ID NO: 184 - protein, 13 aa, Artificial Sequence
  Synthetic peptide
XGDWPFEFEFKFK

SEQ ID NO: 185 - protein, 13 aa, Artificial Sequence
  Synthetic peptide
XGDWPFEFKFEFK

SEQ ID NO: 186 - protein, 8 aa, Artificial Sequence
  Synthetic peptide
FEFKFEFK

SEQ ID NO: 187 - protein, 8 aa, Artificial Sequence
  Synthetic peptide
FEFKFEFK

SEQ ID NO: 188 - protein, 8 aa, Artificial Sequence
  Synthetic peptide
FEFKFEFK

SEQ ID NO: 189 - protein, 5 aa, Artificial
  Synthetic peptide
XGDWP

SEQ ID NO: 190 - protein, 13 aa, Artificial Sequence
  Synthetic peptide
XGDWPFEFKFEFK

SEQ ID NO: 191 - protein, 13 aa, Artificial Sequence
  Synthetic peptide
XGDWPFEFKFEFK

SEQ ID NO: 192 - protein, 5 aa, Artificial
  Synthetic peptide
RGDWP

SEQ ID NO: 193 - protein, 5 aa, Artificial
  Synthetic peptide
RGDWP

SEQ ID NO: 194 - protein, 5 aa, Artificial
  Synthetic peptide
RGDWP